(19) United States
(12) Patent Application Publication
(10) Pub. No.: US 2010/0023384 A1
(43) Pub. Date: Jan. 28, 2010

(54) SYSTEM AND METHOD FOR REWARDING EMPLOYEES OF AN ORGANISATION

(75) Inventors: Alan Pollard, Illovo (ZA); Adrian Gore, Houghton Estate (ZA)

Correspondence Address: PAUL D. BIANCO;Fleit Gibbons Gutman Bongini & Bianco PL, 21355 EAST DIXIE HIGHWAY, SUITE 115, MIAMI, FL, 33180, US

(73) Assignee: DISCOVERY HOLDINGS LIMITED, Sandton (ZA)

(21) Appl. No.: 12/442,549

(22) PCT Filed: Sep. 26, 2007
(86) PCT No.: PCT/IB07/53906

§ 371 Date: May 28, 2009

(30) Foreign Application Priority Data
Sep. 26, 2006 (ZA) 2006/07992

(51) Int. Cl. G06Q 10/00; G06Q 30/00

(52) U.S. Cl. 705/11; 705/14.11; 705/14.2; 705/14.1

(57) ABSTRACT

A system and method of rewarding employees of an organisation are provided. The method includes awarding points to an employee for participation in a plurality of program areas. The total points awarded to the employee for a predetermined period is then calculated and the employee is rewarded with at least one reward depending on the total points awarded to the employee.

### BACKGROUND OF THE INVENTION

This invention relates to a system and method for rewarding employees of an organisation.

A key aspect for the success of any organisation lies in the motivating of employees of the organisation.

The motivating needs to be a holistic motivating whereby employees are motivated not only in terms of performance but in terms of their personal well-being and growth. A healthy employee that is continually striving to improve themselves will be of immense benefit to the organisation.

The present invention seeks to address this.

### SUMMARY

According to a first embodiment there is provided a method of rewarding employees of an organisation, the method including:
awarding points to an employee for participation in a plurality of program areas;
calculating the total points awarded to the employee for a predetermined period; and
rewarding the employee with at least one reward depending on the total points awarded to the employee.

The plurality of program areas may include at least some of health, knowledge, values and contribution.

The program area of health may includes at least one of:
using more than a predetermined percentage of annual vacation leave allocated to the employee; and
participation in a wellness programme.

The program area of knowledge may include at least one of:
passing knowledge assessments of products or services of the company; and
part time studying for further education.

The program area of values may include at least one of:
being a finalist in a performance awards program run by the organisation; and
periodically updating the employees personal details.

The program area of contribution may include at least one of:
volunteering for special projects run by the organisation;
participating in periodic surveys of the organisation; and
recruiting other employees for the organisation.

According to a first embodiment there is provided a system for rewarding employees of an organisation, the system including:
an awards module to award points to an employee for participation in a plurality of program areas;
a calculating module to calculate the total points awarded to the employee for a predetermined period;
a rewards module to reward the employee with at least one reward depending on the total points awarded to the employee.

### BRIEF DESCRIPTION OF THE DRAWINGS

FIG. 1 shows an example method for rewarding employees of an organisation thereby to motivate the employees; and

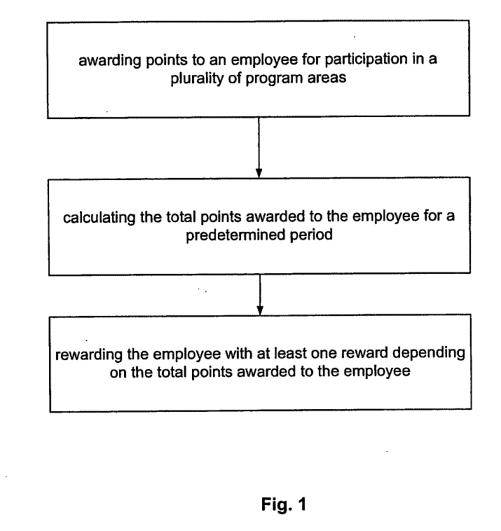

FIG. 2 shows an example system to implement the method of FIG. 1.

### DESCRIPTION OF PREFERRED EMBODIMENTS

According to a first embodiment there is provided a method for rewarding employees of an organisation.

It will be appreciated that the organisation could be any kind of organisation and for purposes of the present invention will be referred to as a company that employs a number of employees

The rewards program is designed to help the employee focus on the aspects that are important to motivate the employee. An example of these would include but would not be limited to:
Looking after their health;
Improving their knowledge;
Living the values of the company; and
Contributing to the company's success.

Thus the program is designed to drive certain desired behaviours with employees, and the rewards encourage this

In one example embodiment, the plurality of program areas include at least some of health, knowledge, values and contribution. These will be explained in much more detail below.

The method includes awarding points to the employee for participation in a plurality of program areas.

Referring first to the program area of health which entails the employee looking after their health, the employee is encouraged to participate in a wellness program operated by the company or a third party.

An example of a wellness program is the Vitality program operated by the applicant. This is disclosed in the applicant's co-pending U.S. patent publication Ser. No. 09/982,274, the contents of which are incorporated herein by reference.

The Vitality program rewards members for utilising approved health related facilities and/or services. For example, members are rewarded for utilising membership of health clubs, membership of gymnasiums, membership of fitness programs, weight loss programs and programs to quit smoking.

Members are also rewarded for using preventive medical procedures, medical advice services and predetermined procedures, for example, pre-authorization of hospitalisation, advance pre-authorisation of treatment, registration for electronic funds transfer and compliance with preferred procedures.

Members are rewarded by a point's allocation system and depending on the total number of points allocated to a member, they fall within one of four statuses. In the implementation of the Vitality program, these statuses have been named in ascending order of value, blue, bronze, silver and gold. All members are placed initially in the blue status. Once a member has accumulated a predetermined number of points, his/her Vitality status is upgraded to the next appropriate level.

To improve the employee's Vitality status, they will need to work on their health—whether through exercise, or appropriate screening, or nutrition, or other lifestyle changes. Thus, if the employee is a Silver or Gold Vitality member, they have put in a lot of effort in this regard, and will be awarded points for doing so. As the member obtains rewards in any event in terms of the Vitality program, they effectively get double incentives for looking after their health.

Thus, the Vitality status of the employee is used to award the employee points. An example of the number of points awarded is:

Being a Bronze Vitality member—1000
Being a Silver Vitality member—2000
Being a Gold Vitality member—4000

Furthermore, the program area of health in an example embodiment includes the employee using more than a predetermined percentage of their annual vacation leave allocated to them.

In an example embodiment, the employee receives 1000 points by taking 80% or more of their entitled annual leave each year within that year.

It is important for the employee to take their annual leave as good rest helps an employee to effectively manage stress. It is also important that the employee is not making mistakes or poor decisions as a result of being overly stressed. Therefore, the employee is encouraged to take the leave that is due to them each year—ideally no less than 80% of their annual leave entitlement.

The program area of knowledge relates to improving the employee's knowledge. Having knowledge of the right facts and being able to successfully apply that knowledge is fundamental to an effective employee.

At the same time, the employee is encouraged to be selective about the subject matter that they invest their time in learning.

In an example embodiment, the employee is awarded points for passing knowledge assessments of products or services of the company. These assessments can be conducted on line, for example using a company's Intranet facility.

Thus the employee could earn 1000 points for passing an assessment. In addition, the employee could earn an extra 2000 points for achieving above 95% for the assessment.

In addition, the program area of knowledge includes awarding points to the employee for part-time studying for further education. Such education could take the form of passing online courses or passing extra mural diploma/degree courses.

In an example embodiment, the employee will earn 500 points per on-line course and 1000 points per year-long module.

The system which implements the present invention and which will be described in more detail below will provide the employee with access to a plurality of online courses to support the employee in success in their career.

To qualify for points it is envisaged that if the study is business related and through a recognised, accredited institution points will be awarded for passing the annual modules each year.

The values program area is a measurement of how the employee lives the values of the company.

For companies that already have an awards program run by the company, points are awarded by an employee being a finalist in this awards program. For example, the applicant runs a “Star Award” program which takes numerous performance and outcomes criteria into consideration. Thus, any employee who makes it to the short-list or the finals must have made a significant impression on their manager and others in the way they live the values and perform in their employment.

In an example embodiment, being on the shortlist for the Star Award process earns 1000 points while being a Star Award quarterly finalist earns 1500 points.

It is envisaged that winners do not get any additional points as winners already get enough of a reward through the Star Award itself.

Another area included in the program area of values is for the employee to periodically update their personal details. This is particularly important in a large company where employee's details are continually changing and the company needs to be kept apprised of the employee's updated information.

Data integrity is important as it is relied upon for numerous other decisions and reporting that go on in a company.

Thus, an employee who updates their information every six months is awarded 500 points.

Included in the program area of contribution is recruiting other employees for the organisation.

Employees mix with a large number of people and so are likely to know one or more people who may be suitable for positions at the company.

Employees are therefore able to encourage a friend or associate to submit their CV directly to the company.

In an example embodiment, if the person is recruited, the employee will be awarded 2000 points.

A further example area within the program area of contribution includes volunteering for special projects run by the organisation.

The special projects could typically be corporate social investment opportunities whereby the company gets involved in the greater community. Employees who volunteer their time for such community social investment will be warded with points.

Examples of such projects could be the Laureus Sport for Good Foundation™, an international body which funds and promotes the use of sports as a tool for social change.

Other projects may include one of a number of projects such as those that aim to raise awareness about child sexual abuse, bridge social divides, develop leaders, teach children to live healthy lives, reduce crime and improve school attendance.

Alternatively, an employee may want to volunteer some time to focus on healthcare through a fund specifically supporting rural interventions and programs addressing HIV/Aids and other infectious diseases.

An employee will be awarded 1000 points for each special project run by the company in which they get involved.

A further example area within the program area of contribution includes participating in surveys.

The best way for a company to monitor its success is to ask its employees and to listen to the feedback. This can be done through a survey.

In one example embodiment, a survey is conducted every six months. One method of doing this is to e-mail the survey to each employee.

Every employee that completes the survey will receive 500 points.

Thus it will be appreciated that the total points awarded to the employee for a predetermined period are calculated and then the employee is rewarded with at least one reward depending on the total points awarded to the employee.

In an example embodiment, points are awarded for a six-month period and at the end of the six-month period, the total points awarded are calculated and then used to determine the reward.

Furthermore, in an example implementation, different statuses are used to determine the reward wherein each of the statuses is a range of points. Thus, for example, the different statuses could be Status One, Status Two, Status Three and Status Four. The higher the employee status, the greater the rewards.

An example of the range of points is as follows:

Status One—1 000 to 5 999 points
Status Two—6 000 to 8 999 points
Status Three—9 000 to 11 999 points
Status Four—12 000 or more points

At the beginning of each new cycle, the employee will start at zero points again and work towards earning more points for the next cycle so that the employee can maintain their status or jump up to the next status and ideally not drop their status.

An example of some of the rewards awarded to the employee are described as follows.

In one example embodiment, the employee is refunded for a certain percentage of their spend on a credit or debit card. The credit or debit card could be issued by the company or by a third party on behalf of the company.

The refund could include all of the expenditure on the credit card or only some of the expenditure items on the credit card.

For example, a refund of 5%-20% (depending on status) of the value of purchases made using the card.

Alternatively, obtaining a refund of between 15%-30% (depending on status) of the value of flights purchased using the card, up to a limit of R3000 every six months.

Other kinds of rewards could include access to excellent holiday deals, ranging from discounts of between 20% and 40%.

In another example, the rewards could be extra annual leave. An example of how this is calculated is as follows:

| | |
|---|---|
| Status Two | Qualify for 0.5 days leave every 6 months |
| Status Three | Qualify for 1 days leave every 6 months |
| Status Four | Qualify for 1.5 days leave every 6 months |

Another example of a reward is to have a prize draw, with the number of tickets in the draw determined by the number of points earned in a cycle. In one example embodiment, the prize draw was for a cash payout of R100,000.

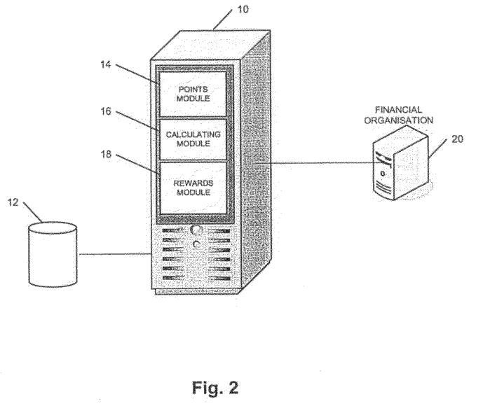

An example system for implementing the above methodologies is illustrated in FIG. 2.

The system includes a server 10 and an associated database 12. The server 10 includes a number of modules to implement the methodologies described above.

A points module 14 awards points to the employee for participation in the program areas.

A calculating module 16 calculates the total points awarded to the employee for a predetermined period and a rewards module 18 rewards the employee with at least one reward depending on the total points awarded to the employee.

In addition, a communications module (not shown) may be included to interface with other systems of the company to communicate with employees via the company e-mail or company intranet.

Typically, the system will include an interface to allow employees to access the system using a communications network to check on the total number of points accumulated.

The system may also be connected to one or more third-party systems to facilitate the redemption of rewards.

An example of one third-party system is illustrated as a server 20 of a financial organisation.

Thus the server 10 can communicate with the server 20 in order to arrange payment of refunds as discussed above

The modules described above may be implemented by a machine-readable medium embodying instructions which, when executed by a machine, cause the machine to perform any of the methods described above.

It will be appreciated that embodiments of the present invention are not limited to such architecture, and could equally well find application in a distributed, or peer-to-peer, architecture system. Thus the modules illustrated could be located on one or more servers operated by one or more institutions.

1. A method of rewarding employees of an organisation, the method including:
awarding points to an employee for participation in a plurality of program areas;
calculating the total points awarded to the employee for a predetermined period; and
rewarding the employee with at least one reward depending on the total points awarded to the employee.

2. A method according to claim 1 wherein the plurality of program areas include at least some of health, knowledge, values and contribution.

3. A method according to claim 2 wherein the program area of health includes at least one of:
using more than a predetermined percentage of annual vacation leave allocated to the employee; and
participation in a wellness programme.

4. A method according to claim 2 wherein the program area of knowledge includes at least one of:
passing knowledge assessments of products or services of the company; and
part time studying for further education.

5. A method according to claim 2 wherein the program area of values includes at least one of:
being a finalist in a performance awards program run by the organisation; and
periodically updating the employees personal details.

6. A method according to claim 2 wherein the program area of contribution includes at least one of:
volunteering for special projects run by the organisation;
participating in periodic surveys of the organisation; and
recruiting other employees for the organisation.

7. A system for rewarding employees of an organisation, the system including:
an awards module to award points to an employee for participation in a plurality of program areas;
a calculating module to calculate the total points awarded to the employee for a predetermined period;
a rewards module to reward the employee with at least one reward depending on the total points awarded to the employee.

8. A system according to claim 7 wherein the plurality of program areas for which the awards module awards points include at least some of health, knowledge, values and contribution.

9. A system according to claim 8 wherein the program area of health includes at least one of:
using more than a predetermined percentage of annual vacation leave allocated to the employee; and
participation in a wellness programme.

10. A system according to claim 8 wherein the program area of knowledge includes at least one of:
passing knowledge assessments of products or services of the company; and
part time studying for further education.

11. A system according to claim 8 wherein the program area of values includes at least one of:
being a finalist in a performance awards program run by the organisation; and
periodically updating the employees personal details.

12. A system according to claim 8 wherein the program area of contribution includes at least one of:
volunteering for special projects run by the organisation;
participating in periodic surveys of the organisation; and
recruiting other employees for the organisation.
